(19) United States
(12) Patent Application Publication
(10) Pub. No.: US 2015/0360953 A1
(43) Pub. Date: Dec. 17, 2015

(54) METHOD FOR PREPARING GRAPHITE USING MICROWAVES

(71) Applicant: POSTECH ACADEMY-INDUSTRY FOUNDATION, Pohang-si, Gyeongsangbuk-do (KR)

(72) Inventors: Tea Won KIM, Gyeongsangbuck-do (KR); Kun Hong LEE, Gyeongsangbuk-do (KR)

(73) Assignee: Postech Academy-Industry Foundation

(21) Appl. No.: 14/763,200

(22) PCT Filed: Jan. 6, 2014
(86) PCT No.: PCT/KR2014/000089

§ 371 Date: Jul. 24, 2015

(30) Foreign Application Priority Data
Feb. 1, 2013 (KR) 10-2013-0011796

(51) Int. Cl. C01B 31/04

(52) U.S. Cl. CPC C01B 31/04

(57) ABSTRACT

The present invention relates to a method for preparing graphite using microwaves, the method comprising: a step for preparing carbon powder; a step for mixing the carbon powder with metal particles to prepare a carbon-metal mixture; and a step for applying microwaves to the carbon-metal mixture. As such, the present invention can obtain high quality graphite from the carbon powder by using microwaves.

### BACKGROUND OF THE INVENTION

1. Field of the Invention

The present invention relates to a method for producing high-quality graphite by using microwaves.

2. Related Art

Production of artificial graphite generally includes a graphitization step of heat treating a carbonaceous material at 3000° C. In the case of a currently used electrical furnace, the atmosphere inside a reactor should be heated first and slow heat transfer mechanisms such as conduction and convection are used, and thus consumption of energy and time is excessive.

On the contrary, in the case of microwave heating using radiation, it is possible to rapid and direct energy transfer, and thus to overcome limitations of the currently used electrical furnace. However, in the case of microwave heating reported to date, it is not possible to reduce an interlayer spacing to less than 3.42 Å, which suggests that complete graphitization is not accomplished.

Korean Laid-Open Patent No. 2010-0122082 relates to high-surface area graphitized carbon and a method for producing the same. This patent discloses increasing a surface area by oxidation or removal of a template phase but uses a high-temperature process as a graphitization process.

### SUMMARY OF THE INVENTION

In an aspect, the present invention provides a method for producing graphite, the method including the steps of: preparing carbon powder; mixing the carbon powder with metal particles to provide a carbon-metal mixture; and applying microwaves to the carbon-metal mixture.

The metal may be a transition metal.

The transition metal may include nickel.

The carbon-metal mixture may be prepared by mixing the carbon powder with the metal in a liquid phase.

The metal may be obtained from nickel chloride.

The microwaves may be applied under inert gas atmosphere.

The microwaves may have a power of 1000 W or higher.

In another aspect, the present invention provides a method for producing graphite, the method including the steps of: preparing a mixture of carbon with a metal; and applying microwaves to the metal to supply heat to the carbon.

The mixture may be in the form of powder and prepared by using carbon powder and nickel chloride.

The mixture may be prepared by mixing the carbon powder with nickel chloride in a liquid phase.

The microwaves may be applied under inert gas atmosphere and may have a power of 1000 W or higher.

According to the present invention, it is possible to produce high-quality graphite by using microwaves.

### BRIEF DESCRIPTION OF THE DRAWINGS

FIG. 1 illustrates the results of X-ray diffractometry of graphite powder before microwave reaction and graphite powder obtained by impregnating carbon powder with nickel chloride and carrying out microwave reaction.

FIG. 2 illustrates the results of X-ray diffractometry of the nickel region in the graphite powder obtained by carrying out microwave reaction after the impregnation of nickel chloride.

FIG. 3 illustrates the results of X-ray diffractometry of a graphitization indicator region depending on a change in concentration of nickel chloride.

FIG. 4 illustrates the results of spectroscopy of graphite powder before microwave reaction and graphite powder obtained by impregnating carbon powder with nickel chloride and carrying out microwave reaction.

FIG. 5 is an image taken by transmission electron microscopy of graphite powder before microwave reaction and graphite powder obtained by impregnating carbon powder with nickel chloride and carrying out microwave reaction.

FIG. 6 illustrates the results of X-ray diffractometry of active carbon.

### DESCRIPTION OF EXEMPLARY EMBODIMENTS

According to an embodiment of the present invention, carbon is mixed with a metal and then graphitized by using microwaves.

As used herein, ‘mixing’ covers not only simple physical mixing but also a chemically bound state.

Since microwaves can transfer energy directly to a desired material without passing through a medium, they are characterized by a high reaction rate. However, since there is a limitation in distance to which microwaves can penetrate into carbon, carbon used as a raw material may be prepared in the form of powder and may be active carbon.

Since a metal has electrical properties characterized by high conductivity, energy is concentrated or reflected on the surface thereof upon the irradiation with microwaves, and may generate high temperature in an instant. Therefore, when applying microwaves after mixing carbon powder with a metal, it is possible to accomplish graphitization within a shorter time as compared to the conventional graphitization process.

Any metal may be used, as long as it has the property of generating high temperature in an instant by microwaves. Preparation of the mixture of carbon with a metal may be carried out by agitating carbon powder with metal powder, but is not limited thereto. However, any method may be used, as long as it allows homogeneous mixing between carbon and a metal.

The metal may be a transition metal, such as nickel, copper, zinc or titanium, and two or more transition metals may be used in combination. A transition metal generally shows good electrical conductivity and has an incomplete electron distribution in its d-subshell, and thus is rich in activated electrons. For this reason, most energy is absorbed at the surface upon the application of microwaves, which causes electric arcs, thereby generating high temperature within a short time.

The transition metal may be used in an amount of 4 mmol to 8 mmol, or 5 mmol to 7 mmol per gram of carbon powder. The metal may be obtained from a metal precursor. When using nickel, nickel chloride may be used as a precursor.

Hereinafter, a method for producing graphite by using nickel chloride as a metal source will be explained.

Carbon powder and nickel chloride are agitated in an aqueous solution to form a carbon-nickel mixture. Then, the carbon-nickel mixture is dried, because non-dried carbon-nickel mixture may have water remaining therein and may cause an undesired reaction and degradation of microwave reaction efficiency.

When microwaves are applied to the resultant powder of carbon-nickel mixture, graphite is formed. The resultant graphite may be in a powder state and may include a trace amount of nickel. When applying microwaves, the carbon-nickel mixture may be present under inert gas atmosphere. When producing graphite, the microwaves may have a power of 1000 W or higher. When the microwaves have a power less than 1000 W, no graphitization occurs or graphitization proceeds very slowly.

Hereinafter, the method for producing graphite using microwaves will be explained in detail with reference to examples. However, the following examples are for illustrative purposes only and not intended to limit the scope of the present invention.

### Experimental Example 1

### Production of Graphite

### a) Nickel Chloride Impregnation

An aqueous nickel chloride solution (using distilled water) is mixed with carbon obtained by heat treating pitch, in a varied amount of 1 mmol, 3 mmol, 5 mmol and 6 mmol per gram of carbon, followed by agitation for at least 12 hours at room temperature. Then, the carbon-metal mixture was dried in an oven at 110° C. for 12 hours. After drying, the carbon-metal mixture was converted into powder again.

### b) Microwave Reaction

The resultant powder of carbon-metal mixture was introduced to a quartz tube and subjected to microwave reaction to obtain graphite. Microwaves of 2.45 GHz were irradiated at a power of 1500 W. Before and during the reaction, argon purge was carried out at 100 sccm to interrupt reaction with oxygen. After the reaction, argon purge was also carried out in an excessive amount and the resultant graphite was taken out after it reached room temperature. The resultant graphite is in the form of powder.

### X-Ray Diffractometry

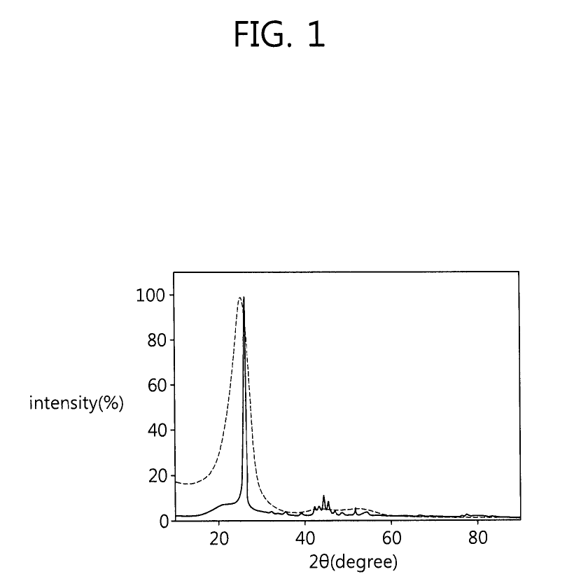

FIG. 1 illustrates the results of X-ray diffractometry of graphite powder (solid line) before microwave reaction and graphite powder (dotted line) obtained by impregnating carbon powder with 6 mmol of nickel chloride and carrying out microwave reaction.

As can be seen from the results of X-ray diffractometry in FIG. 1, after impregnating carbon powder with nickel chloride and carrying out microwave reaction, (002) peak near 26°, used as a graphitization indicator, shifts toward the right side and becomes sharper. This suggests that the interlayer spacing (d-spacing) indicating a degree of graphitization approaches the value of graphite and becomes uniform.

Table 1 shows the XRD data of carbon powder (THFS, THF soluble, coal tar pitch obtained by heat treating its THF-soluble content), the graphite powder (NiCl₂ 6 mmol) obtained from the above experiment, and graphite powder obtained by treating carbon powder at 2600° C. for 1 hour according to the conventional heat treatment method.

It can be seen that the XRD data of the graphite powder obtained from the inventive experiment are similar to the XRD data of the graphite powder obtained according to the conventional heat treatment method. It can be also seen that it is possible to obtain a d-spacing less than 3.42 Å, which cannot be obtained by the conventional heat treatment method.

Therefore, according to the above results, it is possible to ensure that the method according to the present invention provides graphite having similar quality as compared to the graphite obtained according to the conventional heat treatment method.

TABLE 1
Data of d-Spacing Determined by XRD

| Sample | 2θ | d₀₀₂ (Å) | FWHM |
|---|---|---|---|
| THFS(before MW) | 25.64 | 3.4716 | 3.270 |
| NiCl₂ 6 mmol | 26.30 | 3.3860 | 0.698 |
| Thermal (2600° C., 1 h) | 26.38 | 3.3765 | 0.339 |

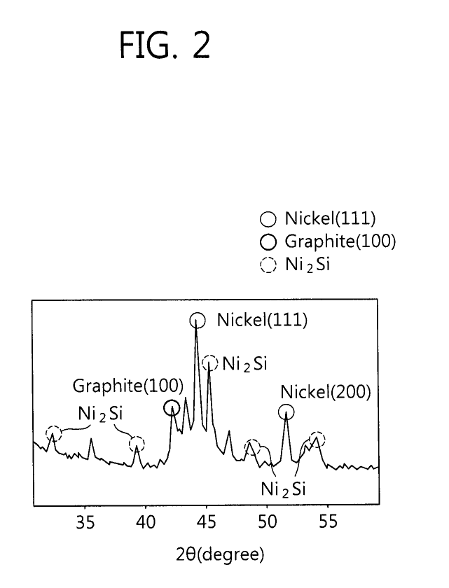

FIG. 2 shows an enlarged view of the nickel peak region in the graphite powder of FIG. 1, obtained by carrying out microwave reaction after the impregnation with 6 mmol of nickel chloride. It can be seen that nickel is present as a mixture of pure nickel with nickel silicide. Therefore, it can be seen that graphite and nickel are present in a simply physically mixed state in the graphite powder obtained according to the present invention.

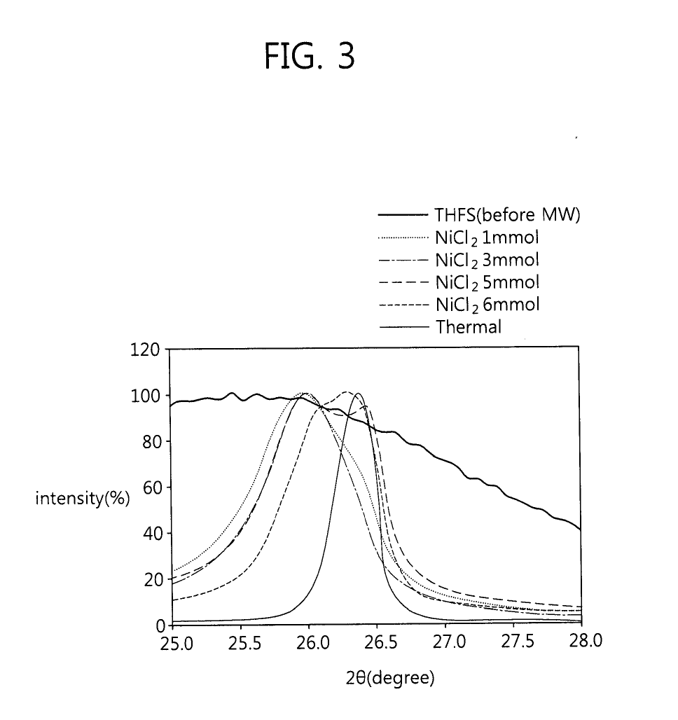

FIG. 3 illustrates the XRD graph of a graphitization indicator region depending on a change in concentration of nickel chloride. As the amount of nickel chloride increases to approach 6 mmol, the XRD graph of graphite become similar to that of the graphite obtained by heat treatment.

### Raman Spectroscopy

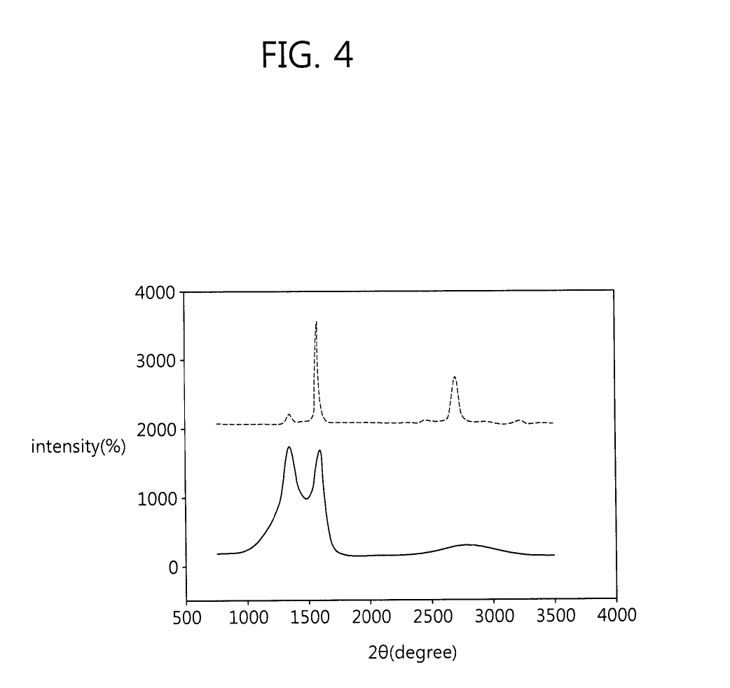

The results of Raman spectroscopy of graphite powder as shown in FIG. 4 further shows a change in structure of carbon powder. It is said that the most specific Raman peak of a carbonaceous material includes G-band (1582 cm⁻¹) observed in well-aligned graphite and D-band (1350 cm⁻¹) observed in a non-aligned structure. It can be said that as the intensity ratio (IG/ID) between the two bands increases, the alignment degree of graphite becomes better.

In FIG. 4, the solid line shows the analysis results of carbon powder before microwave reaction and the dotted line shows the analysis results of graphite powder obtained by impregnating carbon powder with 6 mmol nickel chloride and carrying out microwave reaction.

After the experiment, IG/ID clearly increases from 1.0 (before microwave reaction) to 7.9 (after microwave reaction). Thus, it can be seen that it is possible to obtain high-quality graphite according to the present invention.

### Transmission Electron Microscopy

When the structure of well-aligned graphite is observed with a transmission electron microscope, a hexagonal honeycomb or linearly arranged structure is observed.

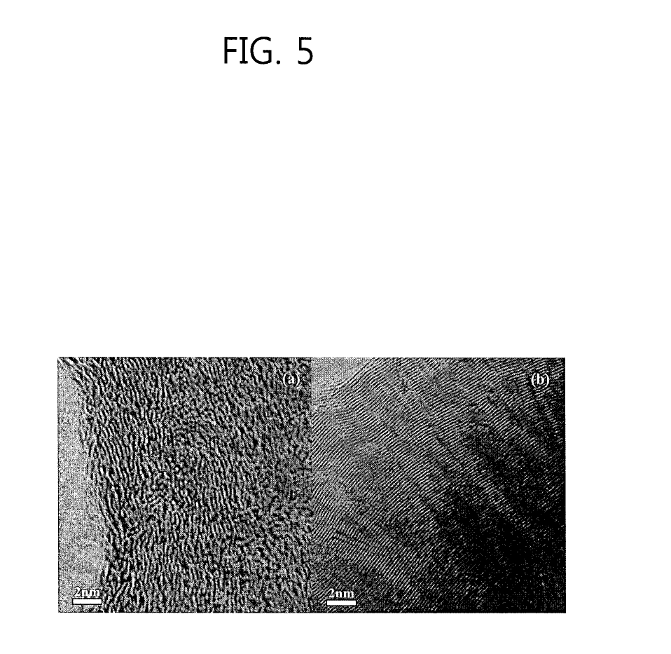

In FIG. 5, the left side (a) shows the transmission electron microscopic image of carbon powder before microwave reaction, and the right side (b) shows the transmission electron microscopic image of graphite powder obtained by impregnating carbon powder with 6 mmol nickel chloride and carrying out microwave reaction. As can be seen from FIG. 5, the carbon powder before microwave reaction has an irregular structure, while the graphite powder obtained by microwave reaction has a well-aligned linear structure.

### Experimental Example 2

### Production of Graphite Using Active Carbon

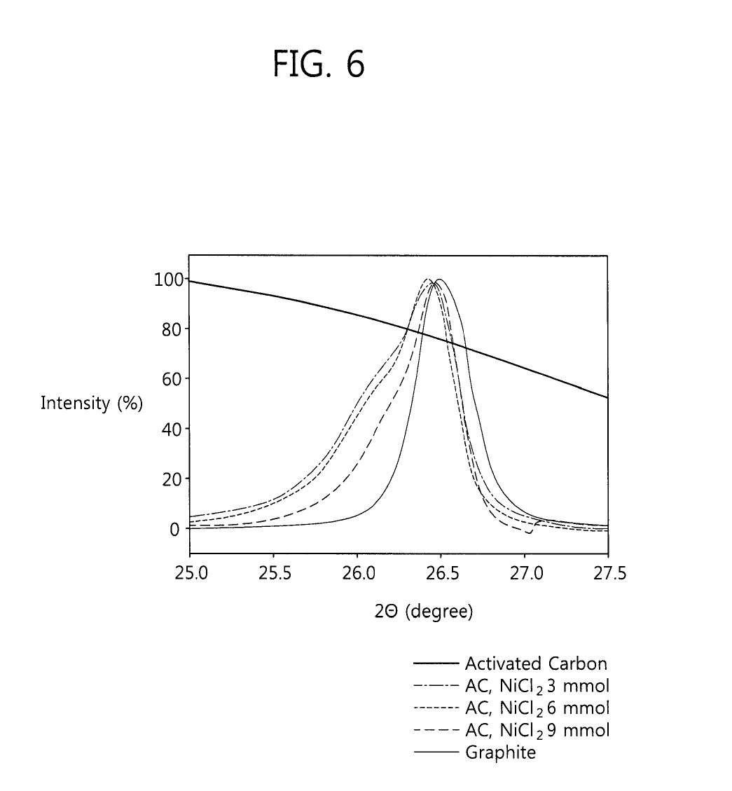

Graphite was produced by using active carbon in the same manner as Experimental Example 1, and the physical properties thereof were determined by XRD. Active carbon was commercially obtained from Sigma Aldrich Co., and graphite as a control was commercially obtained from Samchun Chemical Co. The active carbon has a surface area of about 1500 m²/g. As shown in FIG. 6, (002) peak near 26°, used as a graphitization indicator, does not appear in pure active carbon, while the peak is generated after the impregnation with nickel chloride.

### INDUSTRIAL APPLICABILITY

The present invention is useful for producing high-quality graphite by using microwaves.

What is claimed is:

1. A method for producing graphite, comprising the steps of:
preparing carbon powder;
mixing the carbon powder with metal particles to provide a carbon-metal mixture; and
applying microwaves to the carbon-metal mixture.

2. The method of claim 1, wherein the metal comprises a transition metal.

3. The method of claim 2, wherein the metal comprises nickel.

4. The method of claim 1, wherein the carbon-metal mixture is prepared by mixing the carbon powder with a metal in a liquid phase.

5. The method of claim 4, wherein the metal is obtained from nickel chloride.

6. The method of claim 1, wherein the microwaves are applied under inert gas atmosphere.

7. The method of claim 1, wherein the microwaves have a power of 1000 W or higher.

8. A method for producing graphite, comprising the steps of:
preparing a mixture of carbon with a metal; and
applying microwaves to the metal to supply heat to the carbon.

9. The method of claim 8, wherein the mixture is in the form of powder and prepared by using carbon powder and nickel chloride.

10. The method of claim 9, wherein the mixture is prepared by mixing the carbon powder with nickel chloride in a liquid phase.

11. The method of claim 8, wherein the microwaves are applied under inert gas atmosphere and have a power of 1000 W or higher.
